(19) United States
(12) Patent Application Publication
(10) Pub. No.: US 2016/0072339 A1
(43) Pub. Date: Mar. 10, 2016

(54) POWER RECEIVING APPARATUS, CONTROL METHOD, AND STORAGE MEDIUM

(71) Applicant: CANON KABUSHIKI KAISHA, Tokyo (JP)

(72) Inventor: Takahiro Shichino, Tokyo (JP)

(21) Appl. No.: 14/888,424

(22) PCT Filed: Jun. 20, 2014
(86) PCT No.: PCT/JP2014/067091

§ 371 Date: Oct. 30, 2015

(30) Foreign Application Priority Data
Jun. 26, 2013 (JP) 2013-134214

(51) Int. Cl. H02J 7/02; H02J 7/04

(52) U.S. Cl. CPC H02J 7/025; H02J 7/045

(57) ABSTRACT

Provided is a power receiving apparatus that has an antenna for receiving power and that receives the power wirelessly from a power transmitting apparatus. The power receiving apparatus detects a voltage input into a circuit between the antenna and a load to which the received power is supplied, and adjusts an impedance between the antenna and the load to lower the voltage in the case where the voltage is greater than a predetermined threshold value.

### TECHNICAL FIELD

The present invention relates to wireless power transfer techniques.

### BACKGROUND ART

The development of technology for wireless power transfer systems has become widespread in recent years. Japanese Patent Laid-Open No. 2012-139010 discloses a technique for transferring power with high efficiency through impedance matching between a power receiving antenna and a power generating unit that generates DC power.

A case such as that shown in FIGS. 1A and 1B, where power is transmitted from a single power transmitting apparatus to a plurality of power receiving apparatuses, can be considered as an example of the actual operation of a wireless power transfer system. FIG. 10 is a block diagram illustrating an example of the internal configuration of a typical power transmitting apparatus. In FIG. 10, 1000 indicates a constant voltage source that serves as a power source for a class E amp 1001. 1002 indicates a choke coil that prevents power converted to AC by the class E amp 1001 from returning to the DC constant voltage source 1000, whereas 1003 and 1004 indicate resonant capacitors that resonate with a resonant coil 1005. 1006 and 1007 indicate matching elements for a power transmission antenna coil 1008. 1009 indicates a control unit, such as a CPU, that has a function for controlling the constant voltage source, an oscillator 1010 of the class E amp, and so on. In this type of circuit, the CPU adjusts the voltage of the constant voltage source 1000 so that a current required by the class E amp can be supplied from at least one of the outputs of a voltage detection function and a current detection function (not shown) provided in the constant voltage source.

Next, a case where a state has changed from that shown in FIG. 1A, in which a power transmitting apparatus 100 is transmitting power to two power receiving apparatuses 101 and 102, to that shown in FIG. 1B, where the power receiving apparatus 102 has been removed, will be considered. FIG. 11 shows an example of variation in an output voltage of the constant voltage source 1000 and an AC voltage in the power transmission antenna coil in the power transmitting apparatus 100, and variation in an AC voltage of a power reception antenna coil in the power receiving apparatus 101 that has not been removed, that occur at this time. In FIG. 11, a dotted line indicates a DC output voltage of the constant voltage source 1000 in the power transmitting apparatus 100, a thin solid line indicates the AC voltage at the power transmission antenna coil, and a bold solid line indicates the AC voltage at the power reception antenna coil of the power receiving apparatus 101 that has not been removed. A state (1) indicates a period in which the two power receiving apparatuses 101 and 102 are receiving power, and a time t0 indicates a time at which the power receiving apparatus 102 is removed. A state (3) indicates a period in which power is being supplied in a stable manner to the power receiving apparatus 101 after the power receiving apparatus 102 has been removed, and a state (2) indicates a period of transition from state (1) to state (3).

While power is being transmitted to the two power receiving apparatuses 101 and 102, the power that was to be supplied to the removed power receiving apparatus 102 becomes a surplus immediately after the time t0 at which the power receiving apparatus 102 is removed, resulting in a state of overvoltage in the power transmission antenna coil and the class E amp of the power transmitting apparatus 100. Because the power transmission current drops due to the power transmitted to the removed power receiving apparatus 102 and the resulting surplus power, the CPU reduces the voltage of the constant voltage source 1000 (a time t1). Thereafter, the CPU adjusts the voltage of the constant voltage source 1000 in accordance with a current value required for transmitting power to the power receiving apparatus 101 that has not been removed (a time t2).

At this time, the AC voltage at the power transmission antenna coil rises as indicated by the thin solid line due to the overvoltage, then begins to drop as the output of the constant voltage source 1000 drops, and is adjusted to the voltage indicated in the stable state (3). Because the power reception antenna coil of the power receiving apparatus 101 that has not been removed is in a one-to-one relationship with the power transmission antenna coil of the power transmitting apparatus immediately after the power receiving apparatus 102 is removed and thus couples at a mutual inductance m, the voltage at the power reception antenna coil of the power receiving apparatus 101 at this time enters a state of overvoltage. The voltage occurring in the overvoltage state after the power receiving apparatus 102 has been removed is particularly high in the case where the power receiving apparatus 102 that is removed has been receiving a large amount of power and the power receiving apparatus 101 that is not removed has been receiving a small amount of power. In this case, the power reception antenna coil, a matching element, a rectifier circuit, and so on in the power receiving apparatus 101 that has not been removed, and a constant voltage source connected to the rectifier circuit, may be damaged due to the overvoltage. In addition to cases where power is being transmitted to a plurality of power receiving apparatuses and a power receiving apparatus that is receiving power is removed, the amount of power transmitted from the power transmitting apparatus can also vary drastically due to a driving apparatus such as a motor that is carrying out positional control being switched from a driving state to a stopped state and so on. Accordingly, it has been possible for other power receiving apparatuses to be damaged due to overvoltage in cases where power is being supplied to other apparatuses as well.

Although Japanese Patent Laid-Open No. 2012-139010 attempts to increase the efficiency of wireless power transfer through impedance matching, it does not take into consideration the possibility that an excessive voltage will be input to the power receiving apparatuses as described above.

Having been achieved in light of the aforementioned problems, the present invention prevents an excessive voltage from being inputted to a power receiving apparatus during wireless power transfer.

### SUMMARY OF INVENTION

According to one aspect of the present invention, there is provided a power receiving apparatus that receives power wirelessly from a power transmitting apparatus, the power receiving apparatus comprising: an antenna for receiving the power; first detection means for detecting a voltage input into a circuit between the antenna and a load to which the received power is supplied; and adjustment means for adjusting an impedance between the antenna and the load to lower the voltage in the case where the voltage is greater than a predetermined threshold value.

Further features of the present invention will become apparent from the following description of an exemplary embodiment (with reference to the attached drawings).

### BRIEF DESCRIPTION OF DRAWINGS

The accompanying drawings, which are incorporated in and constitute a part of the specification, illustrate an embodiment of the invention, and together with the description, serve to explain the principles of the invention.

FIGS. 1A and 1B are diagrams illustrating an example of the configuration of a system that transfers power wirelessly.

FIG. 2 is a block diagram illustrating an example of the configuration of a power receiving apparatus.

FIG. 3 is a sequence chart illustrating processing executed by a power transmitting apparatus and two power receiving apparatuses.

FIG. 4 is a flowchart illustrating processing performed by a control unit of a power receiving apparatus.

FIG. 5 is a flowchart illustrating processing performed by a detection unit of the power receiving apparatus.

FIG. 6 is a flowchart illustrating processing performed by a matching unit of the power receiving apparatus.

FIG. 7 is a diagram schematically illustrating information stored in a first storage unit.

FIG. 8 is a diagram schematically illustrating information stored in a second storage unit.

FIG. 9 is a diagram schematically illustrating information stored in a third storage unit.

FIG. 10 is a block diagram illustrating an example of the configuration of a conventional power transmitting apparatus.

FIG. 11 is a diagram illustrating an example of variations in an AC voltage at a power transmission antenna coil, an output DC voltage from a constant voltage source in the power transmitting apparatus, and an AC voltage at a power reception antenna coil of a power receiving apparatus that remains, in the conventional wireless power transfer system.

### DESCRIPTION OF EMBODIMENTS

An exemplary embodiment of the present invention will now be described in detail with reference to the drawings. It should be noted that the relative arrangement of the components, the numerical expressions, and numerical values set forth in the embodiment do not limit the scope of the present invention unless it is specifically stated otherwise.

System Configuration

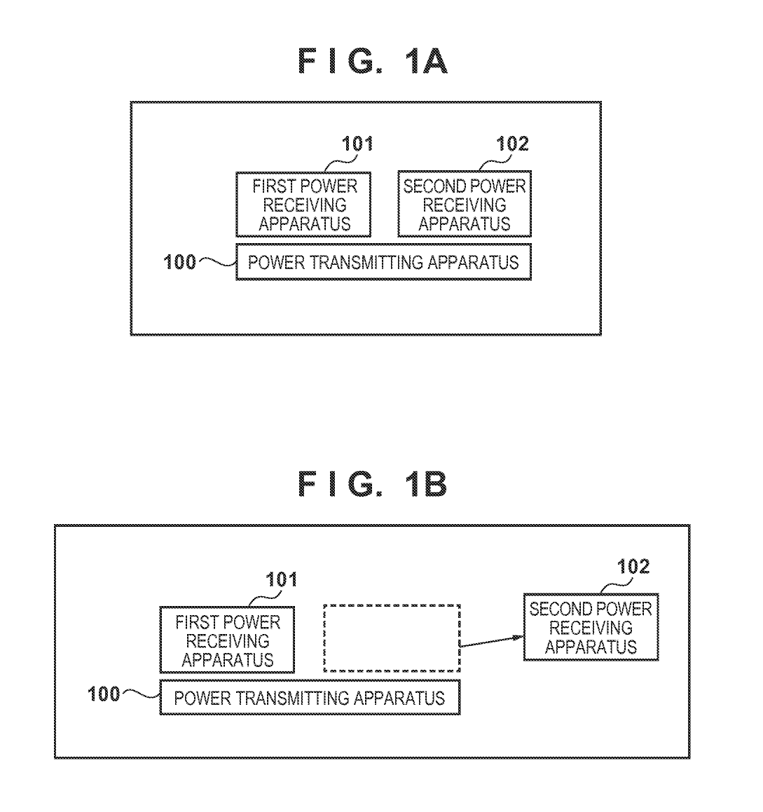

FIGS. 1A and 1B are diagrams illustrating an example of the configuration of a system that transfers power wirelessly according to the present embodiment. In FIGS. 1A and 1B, 100 indicates a power transmitting apparatus, 101 indicates a first power receiving apparatus, and 102 indicates a second power receiving apparatus. FIG. 1A illustrates a state in which the power transmitting apparatus 100 is transmitting power wirelessly to the first power receiving apparatus 101 and the second power receiving apparatus 102, and the first power receiving apparatus 101 and the second power receiving apparatus 102 receive power wirelessly from the power transmitting apparatus 100. Meanwhile, FIG. 1B illustrates a state in which the second power receiving apparatus 102 is removed by a user, or the like, and has moved out of a power transmission range (not shown) of the power transmitting apparatus 100 as a result.

Configuration of Power Receiving Apparatus

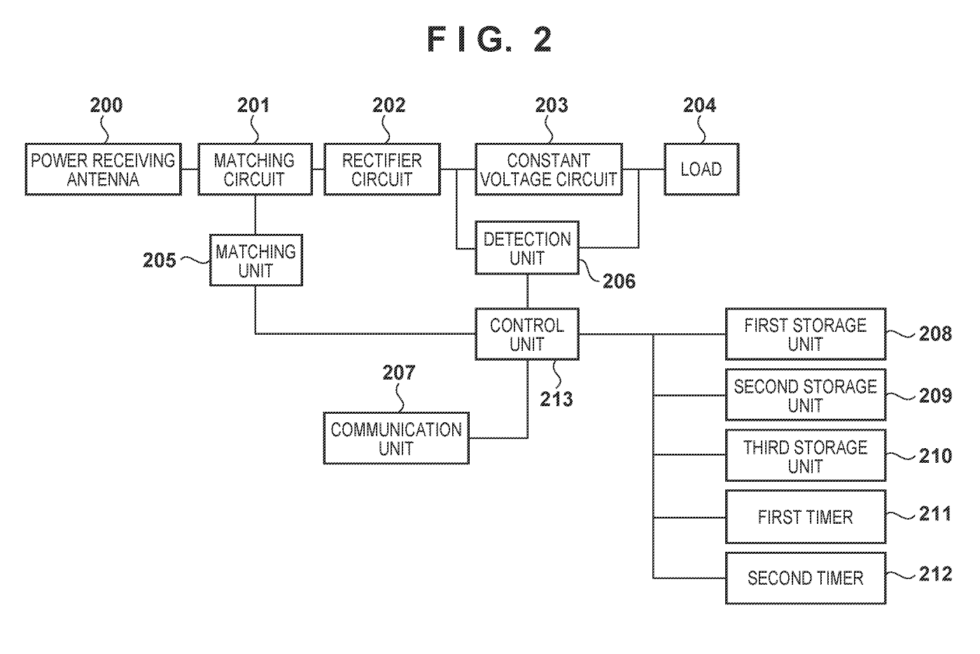

FIG. 2 is a block diagram illustrating an example of the configuration of the power receiving apparatus according to the present embodiment. 200 indicates a power receiving antenna. 201 indicates a matching circuit that has a function for matching an impedance of the power receiving antenna with a load 204-side impedance as viewed from a rectifier circuit 202 (called a “load impedance” hereinafter). The matching circuit is configured of an element such as a capacitor, and the power receiving apparatus has a plurality of such matching circuits, which have the capability of adjusting the impedance by switching in accordance with the load impedance, an input voltage, and so on. For example, in the present embodiment, it is assumed that the matching circuits have ten sets that are combinations of elements, and an appropriate set can be set from among the ten sets in accordance with the load impedance.

203 indicates a constant voltage circuit that converts a DC voltage output from the rectifier circuit to a DC voltage level at which the load 204 operates and supplies that DC voltage to the load 204. In the present embodiment, it is assumed that the constant voltage circuit 203 supplies a DC voltage of 5 volts to the load 204. 205 indicates a matching unit. The matching unit 205 has a function for adjusting the impedance of the power receiving antenna to, for example, match the load impedance by selecting, through a process that will be described later, a single set from the ten sets as mentioned above. 206 indicates a detection unit that detects a voltage input into the constant voltage circuit 203, which is a voltage between the rectifier circuit and the constant voltage circuit 203. The detection unit 206 also has a function for detecting a voltage value and a current value between the constant voltage circuit 203 and the load 204 (these will be called an “output voltage” and an “output current”, respectively, hereinafter).

207 indicates a communication unit that performs at least one of sending and receiving a control signal regarding power transfer to a communication unit (not shown) of the power transmitting apparatus. In the present embodiment, the communication unit 207 is compliant with the Bluetooth (registered trademark) standard version 4.0 (called “BT 4.0” hereinafter). 208 indicates a first storage unit that stores a predetermined value regarding the input voltage detected by the detection unit 206. 209 indicates a second storage unit that stores a plurality of load impedances and IDs of the matching circuits that are optimal for those load impedances. 210 indicates a third storage unit that stores an operating state of the power receiving apparatus. 211 indicates a first timer that prescribes a time interval at which the power receiving apparatus notifies the power transmitting apparatus of the received power currently being received by the power receiving apparatus. 212 indicates a second timer that prescribes a time interval at which the matching unit 205 selects a set of the matching elements held by the matching circuit. Note that a timeout value of the second timer is set to, for example, a lower value than a timeout value of the first timer. 213 indicates a control unit that controls the power receiving apparatus as a whole.

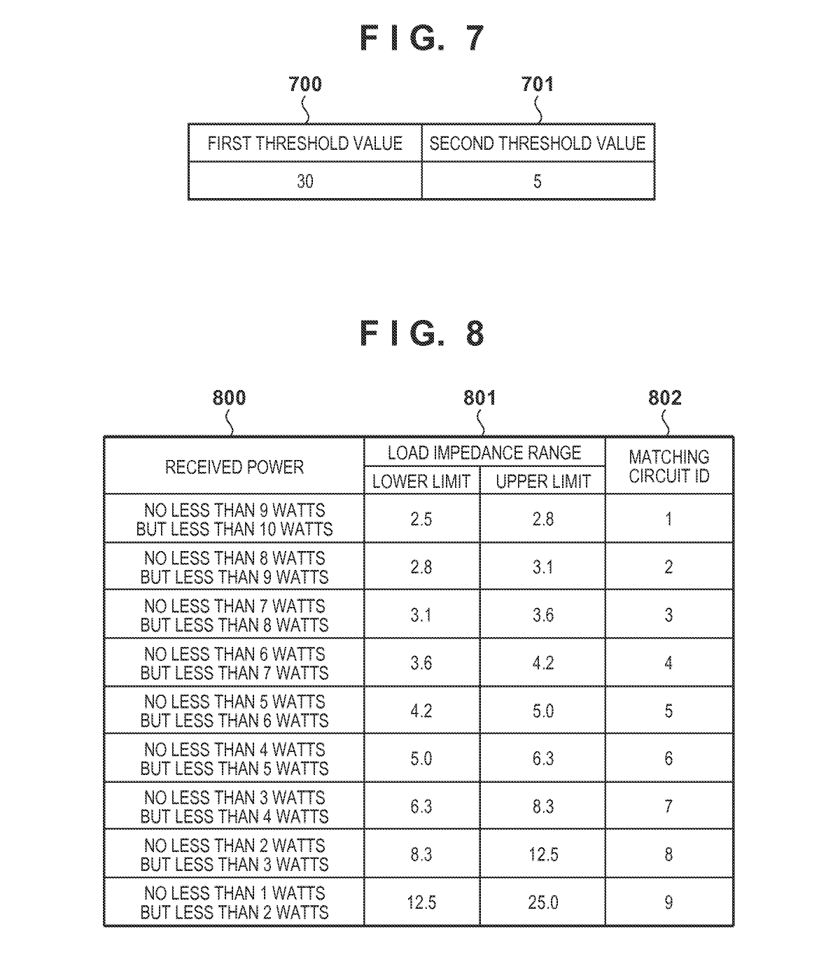

FIG. 7 is a diagram schematically illustrating information stored in the first storage unit 208. The first storage unit 208 stores a voltage range for the input voltage at which the constant voltage circuit 203 operates stably, or in other words, stores a predetermined threshold value. Note that the numerical values in FIG. 7 are in volts. In FIG. 7, 700 indicates a first threshold value that serves as an upper limit value of the input voltage at which the constant voltage circuit 203 operates stably.

Furthermore, 701 indicates a second threshold value that serves as a lower limit value of the input voltage at which the constant voltage circuit 203 operates stably. As shown in FIG. 7, the constant voltage circuit 203 can stably output the aforementioned output voltage (5 volts) as long as the input voltage is between 30 and 5 volts.

FIG. 8 is a diagram schematically illustrating information stored in the second storage unit 209 of a first power receiving apparatus. The second storage unit 209 stores a load impedance corresponding to an amount of power consumed by the load 204 and an optimal matching circuit ID. In the present embodiment, it is assumed that the maximum amount of power consumed by the first power receiving apparatus 101 is 10 watts. Accordingly, a set including a load impedance and an optimal matching circuit ID is stored in the second storage unit 209 for a case where the amount of power consumed is no more than 10 watts.

In FIG. 8, 800 indicates received powers, and in the present embodiment, indicates amounts of power consumed by the load 204. 801 indicates load impedance ranges, whereas 802 indicates matching circuit IDs associated with respective load impedance ranges. Here, identification information regarding the optimal sets of matching circuits is stored as the matching circuit ID for each of a plurality of load impedance ranges.

Next, information stored in the second storage unit 209 as indicated in FIG. 8 will be described for a specific example in which the received power is no less than 9 watts but is less than 10 watts. In the case where the received power is 9 watts, the output voltage is 5 volts, and thus the load impedance is 2.8 ohms, obtained by squaring 5 volts and dividing by 9 watts. Likewise, in the case where the received power is 10 watts, the load impedance is 2.5 ohms, obtained by squaring 5 volts and dividing by 10 watts. Accordingly, in the case where the load impedance is greater than 2.5 ohms and no greater than 2.8 ohms, the matching circuit ID through which impedance matching can be achieved is 1. At this time, impedance matching is achieved between the power receiving antenna and the rectifier circuit, and there is no voltage and power reflection, and thus highly-efficient power transfer is possible. Meanwhile, although the input voltage will change in the case where the impedance matching is not achieved due to the difference between the impedance of the power receiving antenna and the load impedance, it is assumed in the present embodiment that the input voltage is lower the lower the load impedance is. That is, reducing the load impedance makes it possible to reduce the input voltage.

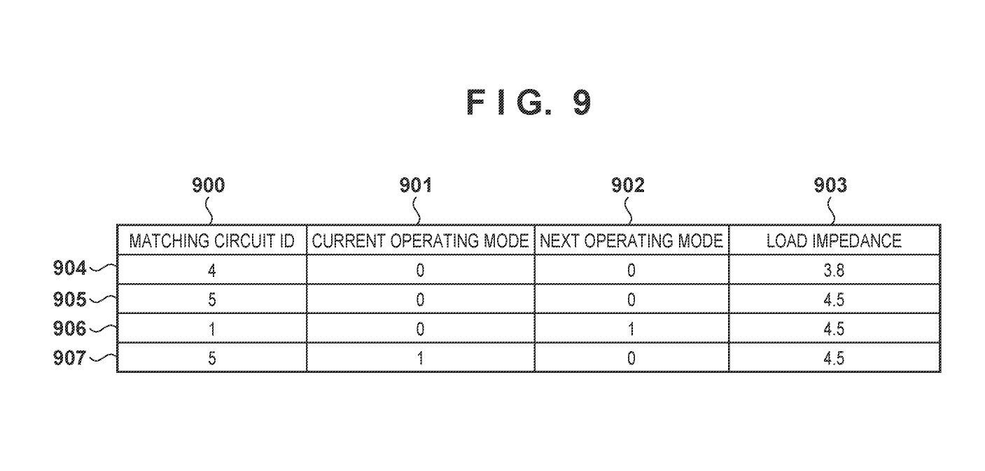

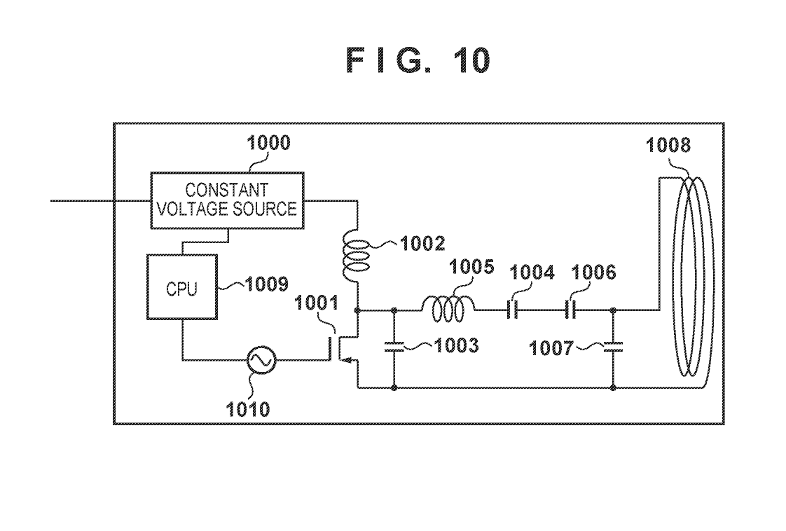

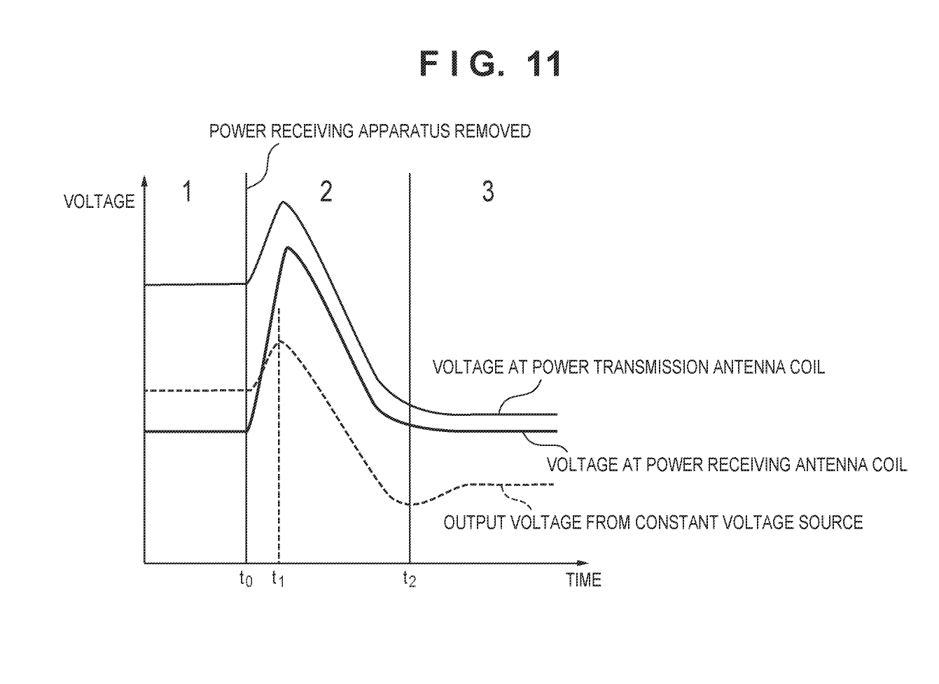

FIG. 9 is a diagram schematically illustrating information stored in the third storage unit 210. In FIG. 9, 900 indicates matching circuit IDs, where identifiers of matching circuits that are to be set are stored. In the present embodiment, it is assumed that an operating mode of the matching unit 205 is determined based on a result of comparing the input voltage with a power threshold value stored in the first storage unit 208. Here, for example, a first operating mode is a mode for executing highly-efficient power transfer through impedance matching, whereas a second operating mode is a mode in which an excessive input voltage is prevented from being applied to the constant voltage circuit 203 by reducing the input voltage. It should be noted that because reducing the input voltage is the purpose of the second operating mode, impedance matching is not of paramount concern, and thus such matching is not achieved.

In the third storage unit 210, a value of “0” for the operating mode indicates the first operating mode, whereas a value of “1” indicates the second operating mode. 902 indicates a next operating mode, and this value is derived as a result of comparing the input voltage with the power threshold value stored in the first storage unit 208. 901 indicates a current operating mode, which is determined, for example, based on a result of comparing the input voltage from the previous cycle with the power threshold value stored in the first storage unit 208. 903 indicates the load impedance. FIG. 9 indicates information stored sequentially in the third storage unit 210 of the first power receiving apparatus as processing advances. In other words, in a state 904, the next operating mode is the first operating mode, and as a result of impedance matching performed in the first operating mode, the matching circuit ID has been changed from 4 to 5 as indicated in a state 905. Likewise, as shown in FIG. 9, the state transits to a state 906 after operating in a state 905, and transits to a state 907 after the state 906. Although the present embodiment describes past states as being stored in the third storage unit 210 for the sake of simplicity, it is not necessary to store past states, and such states may be overwritten and updated.

In the present embodiment, it is assumed that in an initial state, the power received by the first power receiving apparatus is 6.5 watts. The third storage unit 210 stores this initial state (904). According to the information (904) stored in the third storage unit 210, the load impedance is 3.8 ohms, obtained by squaring the output voltage of 5 volts and dividing by the received power of 6.5 watts. Referring to the second storage unit 209, the matching circuit ID suited to a load impedance of 3.8 ohms is “4”, and thus the matching circuit ID in the information (904) stored in the third storage unit 210 is also “4”. This indicates that a matching circuit ID of “4” should be set when the load impedance is 3.8 ohms.

Operations of System and Power Receiving Apparatus

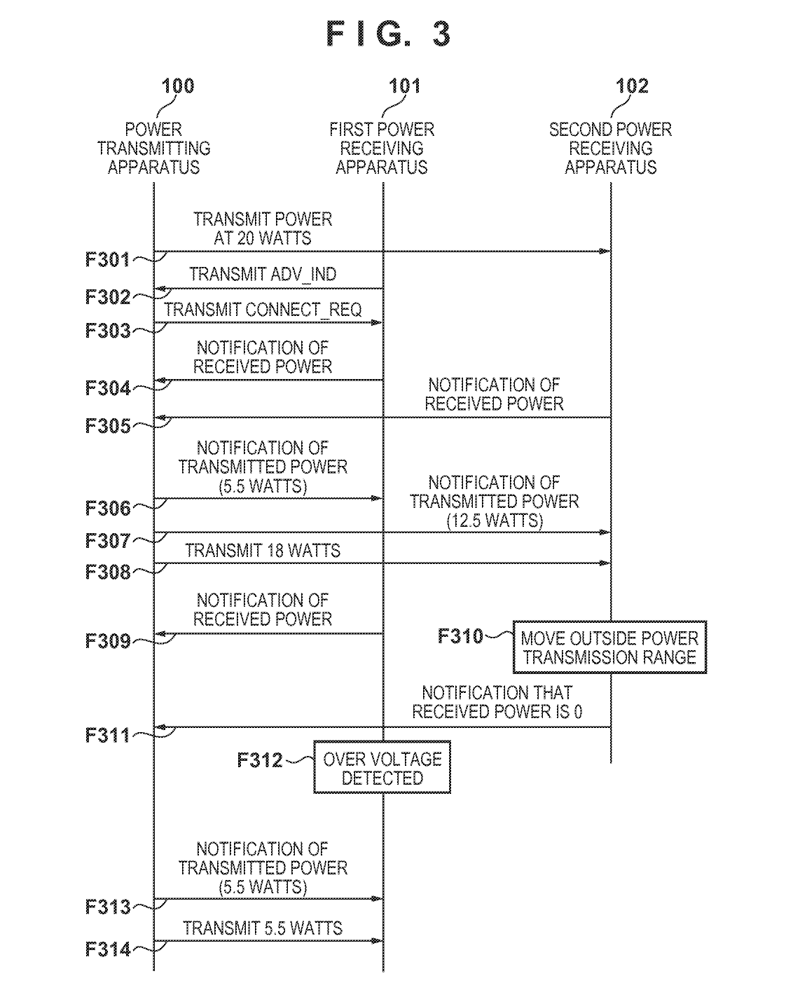

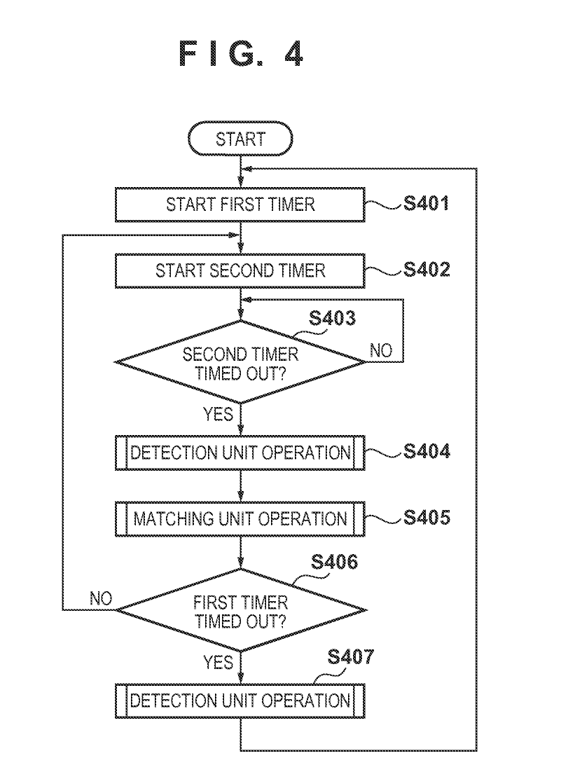

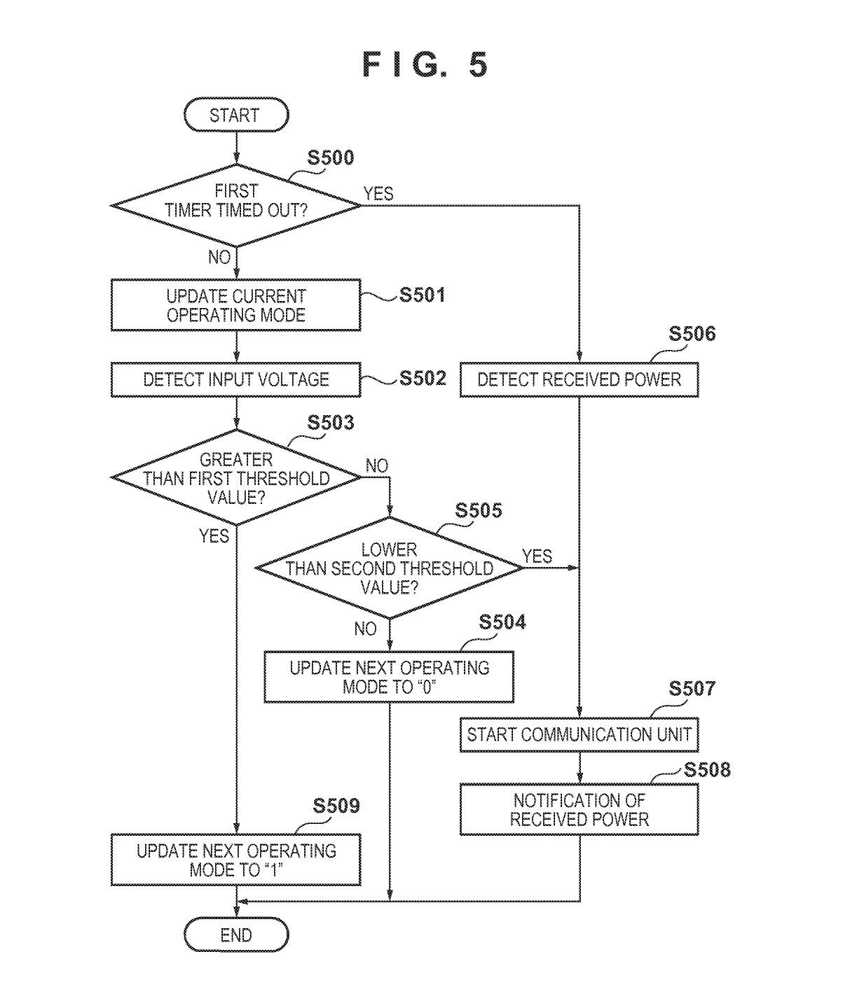

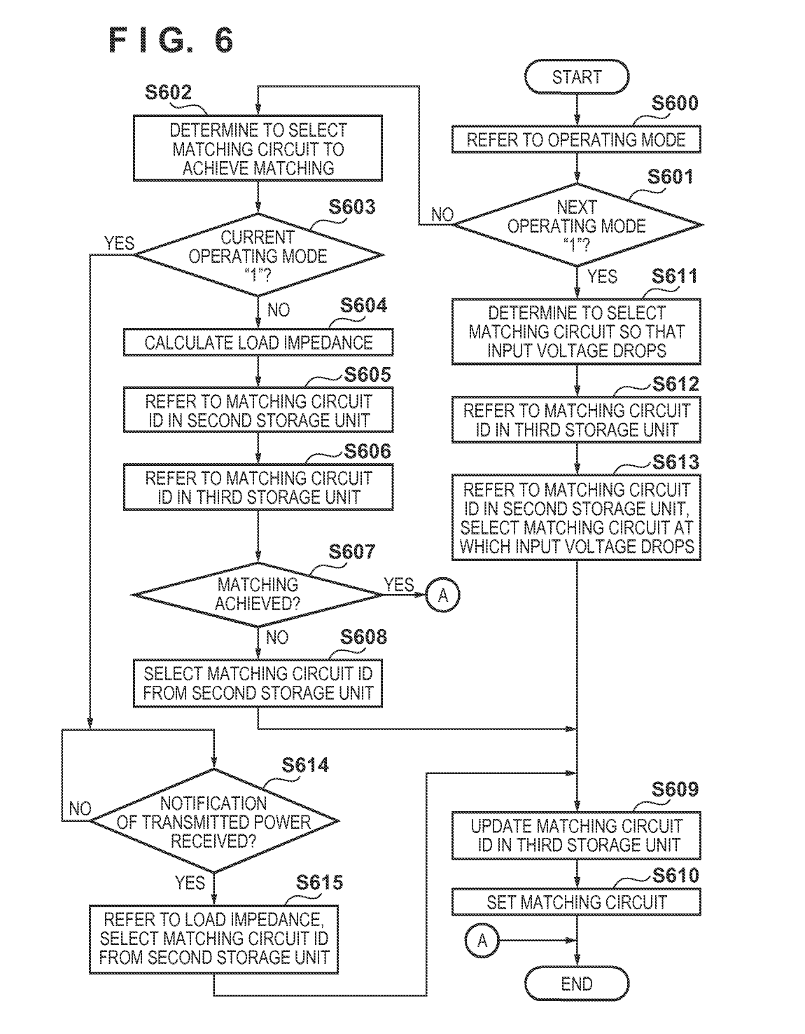

Next, operations performed by the system, and particularly operations performed by the power receiving apparatus, will be described using FIGS. 3 through 6. FIG. 3 is a sequence chart illustrating operations performed by the system, FIG. 4 is a flowchart illustrating an example of processing performed by the control unit 213 of the power receiving apparatus, FIG. 5 is a flowchart illustrating an example of processing performed by the detection unit 206 of the power receiving apparatus, and FIG. 6 is a flowchart illustrating an example of processing performed by the matching unit 205 of the power receiving apparatus.

First, it is assumed that the power received by the first power receiving apparatus is 6.5 watts and the power received by the second power receiving apparatus is 13.5 watts, resulting in a total of 20 watts being transmitted by the power transmitting apparatus (F301). The control unit 213 starts the first timer (S401), and then starts the second timer (S402). When the second timer times out (YES in S402), the control unit 213 causes the detection unit 206 to operate (S404).

Because the timer that timed out in S402 is not the first timer (NO in S500), the detection unit 206 updates the operating mode to the next state from the current state (the initial state; 904 in FIG. 9) (S501). Specifically, because a next operating mode 902 in the current state 904 is “0”, a current operating mode 901 in the updated state 905 is set to “0”. Then, in order to determine the next operating mode in the updated state 905, the detection unit 206 detects the input voltage input into the constant voltage circuit 203 (S502).

The detection unit 206 then compares the input voltage value detected in S502 with the first threshold value stored in the first storage unit 208. In the case where the load 204 is used in applications where the load experiences comparatively low variations, such as the case where the load 204 is configured of a charging circuit and a chargeable battery, a sudden impedance mismatch normally will not occur. Accordingly, it is assumed here that the input voltage is within the voltage range, at which the circuit operates stably (no more than the first threshold value and no less than the second threshold value), stored in the first storage unit 208 (NO in S503 and S505). At this time, the detection unit 206 determines that the constant voltage circuit 203 is operating stably and that the transfer efficiency can be approved by causing the matching unit 205 to operate in the first operating mode and matching the impedances. Accordingly, the detection unit 206 sets the next operating mode 902 in the updated state 905 to “0” (S504), after which the process ends.

Returning to FIG. 4, the control unit 213 then causes the matching unit 205 to operate. The matching unit 205 refers to the operating mode in the information stored in the third storage unit 210 (S600). According to the information 905 stored in the third storage unit 210, the next operating mode is “0” (NO in S601). Accordingly, the matching unit 205 determines that the matching circuit is to be selected in order to match the impedances (S602), and then refers to the current operating mode. According to the information 905 stored in the third storage unit 210, the current operating mode is “0” (NO in S603). Accordingly, the matching unit 205 calculates the load impedance based on the output voltage of the constant voltage circuit 203 and the received power (S604). Here, it is assumed that the received power (the amount of power consumed) has decreased from the aforementioned 6.5 watts to 5.5 watts, due to a change in the state of the load 204 or the like. At this time, the load impedance is 4.5 ohms, obtained by squaring 5 volts and dividing by 5.5 watts. The matching unit 205 then updates the load impedance in the state 905 stored in the third storage unit 210 to “4.5”.

The matching unit 205 then refers to the matching circuit IDs in the second storage unit 209 (S605), and searches for the optimal matching circuit ID when the load impedance is 4.5 ohms. According to FIG. 8, it can be seen that the optimal matching circuit ID is “5” in the case where the load impedance is no less than 4.2 ohms but less than 5 ohms. Then, the matching unit 205 refers to the matching circuit IDs in the information 904 stored in the third storage unit 210 in order to determine the current matching circuit ID (S606).

According to the information 904, the matching circuit ID currently set is “4”, which differs from the “5” searched out in S605. Accordingly, the matching unit 205 determines, from the relationship between the current load impedance and the current matching circuit ID, that the impedances for power receiving do not match (NO in S607), and selects the optimal matching circuit ID of “5” from the second storage unit 209 (S608). Then, after setting the matching circuit ID to “5” in the updated state 905 in the third storage unit 210 (S609), the matching unit 205 sets the matching circuit (S610), and the process ends.

On the other hand, in S607, in the case where it is determined based on the current load impedance and the current matching circuit ID that the impedances match (YES in S607), it is not necessary to change the matching circuit, and thus the process ends directly. Thus in the first operating mode, the efficiency of the power transfer is increased by the matching unit 205 selecting the matching circuit that enables impedance matching in response to a change in the load impedance caused by a change in the amount of power consumed by the load.

Returning to FIG. 4, when the processing performed by the matching unit 205 ends, the control unit 213 determines that the first timer has timed out (S406). If the first timer has not yet timed out (NO in S406), the processes of the aforementioned S402 to S405 are executed again, and the matching circuit is selected and set.

On the other hand, in the case where the first timer has timed out (YES in S406), the control unit 213 causes the detection unit 206 to operate (S407). In this case, because the first timer has timed out (YES in S500), the detection unit 206 detects the output voltage and the output current of the constant voltage circuit 203, and calculates the received power by multiplying those values (S506). Here, an output voltage of 5 volts and an output current of 1.1 amperes are detected, and thus 5.5 watts is detected as the received power.

Next, the detection unit 206 starts the communication unit 207 (S507). Then, after a wireless connection has been established with a communication unit (not shown) of the power transmitting apparatus 100, the detection unit 206 notifies the power transmitting apparatus 100 of the detected received power (S508). Specifically, an ADV_IND packet, which is one type of advertising packet defined in the BT 4.0 standard, is transmitted from the power receiving apparatus 101 to the power transmitting apparatus 100 (F302). The ADV_IND packet holds information such as address information of BT 4.0-compliant devices, services supported by upper-layer applications, and so on. The power transmitting apparatus 100 transmits a CONNECT_REQ packet in response to the ADV_IND packet in order to establish the wireless connection with the first power receiving apparatus. At this point in time, the communication unit (not shown) of the power transmitting apparatus 100 and the communication unit 207 of the first power receiving apparatus 101 are wirelessly connected through BT 4.0, and are thus capable of communicating using BT 4.0.

After the wireless connection has been established, the communication unit 207 notifies the power transmitting apparatus 100 of information including a value of 5.5 watts as the received power detected in S506 (F304, S508), after which the process ends. Likewise, the second power receiving apparatus 102 establishes a wireless connection with the power transmitting apparatus 100, and notifies the power transmitting apparatus 100 of information indicating the received power (F305). It is assumed that the second power receiving apparatus 102 communicates a value of 12.5 watts as the received power at this time.

Upon receiving the information indicating the received power, the power transmitting apparatus 100 adjusts the transmitted power, and notifies the power receiving apparatuses 101 and 102 of information indicating that transmitted power. Specifically, the first power receiving apparatus 101 is notified that 5.5 watts will be transmitted (F306), and the second power receiving apparatus 102 is notified that 12.5 watts will be transmitted (F307). As a result, the power transmitting apparatus 100 adjusts the transmitted power from 20 watts, which is the amount of power transmitted up until that point, to 18 watts, which is the total of the transmitted power values notified here, and then transmits the adjusted power to the first power receiving apparatus 101 and the second power receiving apparatus 102 (F308). The power transmitting apparatus 100 can periodically adjust the transmitted power based on the received power as a result of the plurality of power receiving apparatuses performing a process for connecting to the power transmitting apparatus 100 and notifying the power transmitting apparatus 100 of the received power each time the first timer times out in this manner. Doing so makes it possible to achieve balance between the transmitted power and the received power; power that returns to the power transmitting apparatus 100 due to an imbalance is eliminated, which in turn makes it possible to improve the efficiency of power transmission throughout the overall system. Furthermore, setting the timeout value of the second timer to a lower value than the timeout value of the first timer makes it possible for the power transmitting apparatus 100 to control the transmitted power without a drop in efficiency caused by reflection in the power receiving apparatuses, which in turn makes it possible for the power transmitting apparatus 100 to transmit an appropriate amount of power.

Then, at F309, the communication unit 207 of the first power receiving apparatus 101 notifies the power transmission apparatus 100 of the received power in the same manner as in F304. The received power at this time is the same 5.5 watts as in F305. Meanwhile, it is assumed here that the second power receiving apparatus 102 has moved outside of the power transmission range of the power transmitting apparatus 100, as indicated in FIG. 1B (F310). At this time, the detection unit 206 of the second power receiving apparatus 102 detects that the voltage input into the constant voltage circuit 203 has dropped below the second threshold value due to this movement (YES in S505), and detects that the constant voltage circuit 203 is no longer capable of operating stably. Accordingly, the second power receiving apparatus 102 notifies the power transmitting apparatus 100 that the received power is 0 (F311).

The notification in F311 may be any type of notification as long as it is information that notifies the power transmitting apparatus 100 that power need not be transmitted to the second power receiving apparatus 102 thereafter. For example, the notification may be a notification that the second power receiving apparatus 102 will no longer receive power, a notification indicating a request to stop the transmission of power to the second power receiving apparatus 102, a notification that the second power receiving apparatus 102 cannot operate stably, or the like.

Due to the movement, the impedance is no longer matched between the first power receiving apparatus 101 and the power transmitting apparatus 100, and thus the voltage input to the first power receiving apparatus 101 changes greatly. Accordingly, the detection unit 206 of the first power receiving apparatus 101 detects that the voltage input to the constant voltage circuit 203 has risen above the first threshold value (YES in S503). In other words, at this point in time, the first power receiving apparatus 101 detects that overvoltage, at which the constant voltage circuit 203 cannot operate stably, has been applied (F312). In this case, the first power receiving apparatus 101 determines that it is necessary to cause the matching circuit to operate in the second operating mode and lower the voltage input into the constant voltage circuit 203. Accordingly, the detection unit 206 sets the next operating mode in the updated state 906 to “1” (S509), after which the process ends.

Because the next operating mode is “1” (YES in S601), the matching unit 205 determines that a matching circuit is to be selected in order to lower the input voltage (S611). The matching unit 205 then refers to the matching circuit IDs in the third storage unit 210 (S612). Here, based on the current state 905, the matching circuit ID at this point in time is “5”. Accordingly, the matching unit 205 selects a matching circuit at which the input voltage will be lower than when the matching circuit ID is “5”. As described earlier, in the present embodiment, the lower the load impedance is (that is, the lower the matching circuit ID is), the lower the input voltage will be.

Accordingly, the matching unit 205 refers to the matching circuit IDs in the second storage unit 209 and selects the matching circuit at which the input voltage will be lower (S613). Specifically, the matching unit 205 selects, for example, the matching circuit ID “1”, in which the input voltage will be lower than with the current matching circuit ID of “5”. Then, after setting the matching circuit ID to “1” in the updated state 906 in the third storage unit 210 (S609), the matching unit 205 sets the matching circuit and adjusts the impedance (S610), after which the process ends.

The power transmitting apparatus 100 adjusts the transmitted power based on the information received in F309 and F311. Specifically, the power transmitting apparatus 100 notifies the first power receiving apparatus 101 that 5.5 watts will be transmitted (F314), but does not notify the second power receiving apparatus 102 of the transmitted power. Note that the power transmitting apparatus 100 may issue a notification that power will not be transmitted in response to receiving a notification from the second power receiving apparatus 102 that the received power is 0. Then, the power transmitting apparatus 100 starts transmitting 5.5 watts of power, which is the total transmitted power notified as described above (F315). As a result, at this point in time, the power transmitting apparatus lowers the transmitted power from 18 watts to 5.5 watts.

Meanwhile, at this point in time, in the first power receiving apparatus 101, the operating mode of the matching unit 205 changes from the first operating mode to the second operating mode, and the input voltage drops. At this time, the matching circuit whose matching circuit ID is “1” is set, and the power transmitted by the power transmitting apparatus 100 has also dropped, and thus the detection unit 206 of the first power receiving apparatus 101 detects that the voltage input to the constant voltage circuit 203 has dropped below the first threshold value (NO in S503). Accordingly, the detection unit 206 sets the next operating mode in the updated state 907 to “0” (S504).

Here, the current operating mode is set to “1” in the updated state 907 by the detection unit 206 (S501). Accordingly, the matching unit 205 operates based on the current operating mode (NO in S601; YES in S603), and stands by to operate until receiving a transmitted power notification from the power transmitting apparatus (S604). This is because in the case where the operating mode returns to the first operating mode despite the power transmitted by the power transmitting apparatus 100 not having dropped, overvoltage may be detected again. It is necessary for the power receiving apparatus to return to the first operating mode from the second operating mode upon confirming that the power transmitting apparatus 100 has lowered the transmitted power and overvoltage is not detected.

Upon receiving a notification from the power transmitting apparatus 100 that the transmitted power will be lowered to 5.5 watts (YES in S604), the matching unit 205 returns operating mode to the first operating mode in F314. Then, the matching unit 205 refers to the load impedances in the third storage unit 210, and selects optimal matching circuit ID from the second storage unit 209 (S615). Specifically, the matching unit 205 refers to the state 907, and selects the matching circuit ID of “5”, which is optimal for a load impedance of 4.5 ohms. Then, after updating the matching circuit ID to “5” in the state 907 (S609), the matching unit 205 sets the matching circuit and adjusts the impedance (S610), after which the process ends. In this manner, the matching unit 205 returns the operating mode to the first operating mode.

Although the matching unit 205 returns the operating mode to the first operating mode after the notification in F314 here, it should be noted that this is performed so that overvoltage is not detected again. Accordingly, another method that makes it possible to detect that overvoltage has not occurred again may be used instead. For example, the matching unit 205 may detect that the transmitted power has actually dropped as a result of the detection unit 206 detecting a drop in the voltage input to the constant voltage circuit 203, and may return the operating mode to the first operating mode after that drop has occurred.

As described thus far, the power receiving apparatus can reduce the risk that the constant voltage circuit will be damaged by overvoltage being continuously applied thereto by operating in the second operating mode in the case where a result of the detection unit 206 detecting the input voltage is greater than a first threshold value. In addition, a state in which the constant voltage circuit 203 can operate stably can be maintained by transiting to the second operating mode and adjusting the voltage input into the constant voltage circuit 203. Through this, the first power receiving apparatus 101 can supply a stable voltage to a load even in the case where the impedance has changed suddenly, such as when the second power receiving apparatus 102 has been removed.

Furthermore, the power receiving apparatus can prevent a state of overvoltage from recurring by returning the operating mode to the first operating mode only after confirming that overvoltage will not be applied after operating in the second operating mode. As a result, a stable voltage can be continuously supplied to the load. In addition, the power transmitting apparatus can periodically change the transmitted power based on the received power as a result of the power receiving apparatus performing a process for connecting to the power transmitting apparatus and communicating the received power each time the first timer times out. As a result, the transmitted power and the received power can be balanced, and the efficiency of power transfer can be improved throughout the system as a whole. Furthermore, setting the timeout value of the second timer to a lower value than the timeout value of the first timer makes it possible for the power transmitting apparatus to control the transmitted power without a drop in efficiency caused by reflection in the power receiving apparatus. Accordingly, the power transmitting apparatus can control the transmitted power in a state of high efficiency and with little loss.

In addition to the configurations described above, the same effects can be achieved by the individual configurations described hereinafter, or by combinations thereof.

Although the foregoing describes the load impedance as being calculated from the output voltage and the received power, the load impedance may be calculated from the output voltage and the output current.

In addition, although the foregoing describes the advertising packets as the ADV_IND packet and the CONNECT_REQ packet, these packets may be other types of advertising packets defined in BT 4.0. Furthermore, although the communication units are described as being compliant with BT 4.0, the communication units may be compliant with another communication standard. This communication standard may be, for example, another BT standard, wireless LAN, Zigbee (registered trademark), NFC, or the like.

Furthermore, in the above descriptions, the matching unit 205 compares the matching circuit ID in the third storage unit 210 with the matching circuit ID in the second storage unit 209 and selects the matching circuit to be set, during the second operating mode. However, instead, a dedicated matching circuit for the second operating mode may be provided in advance, and this matching circuit provided in advance may be selected upon transiting to the second operating mode without carrying out a comparison. Specifically, a matching circuit may be provided for the case where, for example, the received power exceeds 10 watts (the load impedance is lower than 2.5 ohms), with a matching circuit ID of “0” in the second storage unit 209. Through this, even in the case where, for example, a matching circuit whose matching circuit ID is “1” is set, a matching circuit “0” can be selected in order to reduce the received voltage.

In addition, although the foregoing describes the matching unit 205 as selecting the matching circuit ID of “1”, in order to achieve the lowest received voltage, when the current matching circuit ID is “5” in S613, a different matching circuit ID may be selected.

For example, the matching unit 205 may select a matching circuit ID that is lower than “5”, or in other words, “4” or less, and may perform adjustment by selecting matching circuits in steps until the voltage input into the constant voltage circuit 203 no longer exceeds the first threshold value. For example, the matching unit 205 may select the matching circuit ID of “4” in S613, after which the detection unit 206 determines in S503 that the voltage input to the constant voltage circuit 203 is greater than the first threshold value. Then, the matching unit 205 may perform S613 again and select the matching circuit ID of “3”, after which the detection unit 206 determines in S503 whether the voltage input to the constant voltage circuit 203 exceeds the first threshold value. Repeating this process makes it possible to identify the matching circuit ID at which the voltage input into the constant voltage circuit 203 will be no greater than the first threshold value.

As another example, the matching unit 205 selects the matching circuit ID of “2” in S613. Then, the detection unit 206 determines in S503 that the voltage input to the constant voltage circuit 203 does not exceed the first threshold value. In this case, the matching unit 205 performs S613 again and selects the matching circuit ID of “3”. Then, the detection unit 206 determines in S503 whether the voltage input to the constant voltage circuit 203 exceeds the first threshold value. The selection of the matching circuit ID is repeated until the voltage input into the constant voltage circuit 203 exceeds the first threshold value. Through this, the matching unit 205 can select, for example, the matching circuit ID of “2”, at which the voltage input into the constant voltage circuit 203 does not exceed the first threshold value.

Through this, impedance mismatching can be suppressed to the greatest extent possible while also lowering the received voltage, and thus a drop in the efficiency of the power transfer in the system can be suppressed to the greatest extent possible while also preventing overvoltage from being applied.

According to the present invention, an excessive voltage can be prevented from being inputted to a power receiving apparatus during wireless power transfer.

### Other Embodiments

Embodiments of the present invention can also be realized by a computer of a system or apparatus that reads out and executes computer executable instructions recorded on a storage medium (e.g., non-transitory computer-readable storage medium) to perform the functions of the above-described embodiment of the present invention, and by a method performed by the computer of the system or apparatus by, for example, reading out and executing the computer executable instructions from the storage medium to perform the functions of the above-described embodiment. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-134214, filed Jun. 26, 2013, which is hereby incorporated by reference herein in its entirety.

1. A power receiving apparatus that receives power wirelessly from a power transmitting apparatus, the power receiving apparatus comprising:
an antenna for receiving the power;
a first detection unit configured to detect a voltage input into a circuit between the antenna and a load to which the received power is supplied; and
an adjustment unit configured to adjust an impedance between the antenna and the load to lower the voltage in the case where the voltage is greater than a predetermined threshold value.

2. The power receiving apparatus according to claim 1,
wherein the adjustment unit matches the impedance of the antenna with the impedance of the load in the case where the voltage is no greater than the threshold value.

3. The power receiving apparatus according to claim 1, further comprising:
a second detection unit configured to detect that the power transmitting apparatus has lowered a transmitted power,
wherein the adjustment unit further matches the impedance of the antenna with the impedance of the load in the case where the impedance has been adjusted to lower the voltage and it has been detected that the transmitted power has been lowered.

4. The power receiving apparatus according to claim 3,
wherein the second detection unit detects that the transmitted power has been lowered by receiving a notification that the transmitted power will be lowered from the power transmitting apparatus.

5. The power receiving apparatus according to claim 1,
wherein the adjustment unit further matches the impedance of the antenna with the impedance of the load to match in the case where the impedance has been adjusted to lower the voltage and the first detection unit has detected that the voltage has dropped.

6. The power receiving apparatus according to claim 1,
wherein the adjustment unit adjusts the impedance by switching among a plurality of different circuits.

7. A control method for a power receiving apparatus that has an antenna for receiving power and that receives the power wirelessly from a power transmitting apparatus, the method comprising:
detecting a voltage input into a circuit between the antenna and a load to which the received power is supplied; and
adjusting an impedance between the antenna and the load to lower the voltage in the case where the voltage is greater than a predetermined threshold value.

8. A non-transitory computer-readable storage medium storing a computer program for causing a computer including a power receiving apparatus that has an antenna for receiving power and that receives the power wirelessly from a power transmitting apparatus to:
detect a voltage input into a circuit between the antenna and a load to which the received power is supplied; and
adjust an impedance between the antenna and the load to lower the voltage in the case where the voltage is greater than a predetermined threshold value.
